(19) United States
(12) Patent Application Publication
(10) Pub. No.: US 2008/0301391 A1
(43) Pub. Date: Dec. 4, 2008

(54) METHOD AND APPARATUS FOR MODIFYING A BURST LENGTH FOR SEMICONDUCTOR MEMORY

(76) Inventor: Jong-Hoon Oh, Chapel Hill, NC (US)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 11/757,135

(22) Filed: Jun. 1, 2007

(51) Int. Cl. G06F 12/00

(52) U.S. Cl. 711/167; 711/104; 711/E12.078

(57) ABSTRACT

A method and apparatus for performing a burst access operation for a memory device. The method includes receiving a burst access command for the burst access operation and receiving a burst length modifying value for the burst access operation. A modified burst length is generated from a pre-programmed burst length using the burst length modifying value. The modified burst length is used for the burst access operation without changing the pre-programmed burst length. The burst access operation is performed with the modified burst length.

### BACKGROUND OF THE INVENTION

Modern memory devices are typically used to store data and instructions which are processed by a processor connected to the memory device. In order to increase the amount of data and/or instructions processed by the processor, increased input and output of stored data (referred to as memory bandwidth) for a memory device is typically desired. In some cases, to improve memory bandwidth, a memory device may provide circuitry for performing a burst access operation. During a burst access operation, multiple items of information may be quickly read from (a burst read operation) or written to (a burst write operation) the memory device.

In some cases, the burst access operation provided by a memory device may be limited to transmitting a specific number of items of information (referred to as the burst length). The burst length may be programmed into the memory device. In some cases, performing a burst access operation with a pre-programmed burst length may be inefficient. For example, there may be a desire to perform a burst operation in which less information than the pre-programmed burst length is transmitted or to perform a burst operation in which more information than the pre-programmed burst length is transmitted. Because the burst access operation may be limited to the pre-programmed burst length, the burst access operation may provide insufficient memory bandwidth or may unnecessarily use memory bandwidth during the access.

Accordingly, what is needed is an improved memory device and method for performing a burst operation with a configurable burst length.

### SUMMARY OF THE INVENTION

Embodiments of the invention generally provide a method and apparatus for performing a burst access operation for a memory device. In one embodiment, the method includes receiving a burst access command for the burst access operation and receiving a burst length modifying value for the burst access operation. A modified burst length is generated from a pre-programmed burst length using the burst length modifying value. The modified burst length is used for the burst access operation without changing the pre-programmed burst length. The burst access operation is performed with the modified burst length.

One embodiment of the invention provides a memory device, including circuitry configured to receive a burst access command for a burst access operation and receive a burst length modifying value for the burst access operation. The circuitry is further configured to generate a modified burst length from a pre-programmed burst length using the burst length modifying value. The modified burst length is used for the burst access operation without changing the pre-programmed burst length. The circuitry is further configured to perform the burst access operation with the modified burst length.

One embodiment of the invention also provides a controller including circuitry configured to issue a burst access command for a burst access operation to a memory device and provide a burst length modifying value for the burst access operation to the memory device. The burst length modifying value is used to generate a modified burst length from a pre-programmed burst length. The modified burst length is used for the burst access operation without changing the pre-programmed burst length. The burst access operation is performed with the modified burst length.

One embodiment of the invention further provides a method for performing a burst access operation for a memory device. The method includes receiving a burst access command for the burst access operation and receiving a burst start value for the burst access operation. The method also includes initializing a counter to the burst start value determining a length of the burst access operation using the counter initialized to the burst start value. The burst access operation is completed when the counter reaches an end of burst value.

One embodiment of the invention also provides a method for performing a burst access operation for a memory device. The method includes receiving a burst access command for the burst access operation and receiving a burst shift value for the burst access operation. The method also includes generating a modified burst length from a pre-programmed burst length by shifting the pre-programmed burst length to one of a plurality of shifted burst length values using the burst shift value. The burst access operation is performed with the modified burst length.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-B are block diagrams depicting a memory device and memory controller according to one embodiment of the invention.

FIG. 2 is a block diagram depicting exemplary commands for a burst access operation which uses a burst length start value according to one embodiment of the invention.

FIG. 3 is a block diagram depicting burst access circuitry for performing burst access operations according to one embodiment of the invention.

FIG. 4 is a flow diagram depicting a process 400 for performing a burst access operation with a burst length start value according to one embodiment of the invention.

FIGS. 5A-B are block diagrams depicting timing of a burst access operations which utilize a burst length start value according to one embodiment of the invention.

FIG. 6 is a block diagram depicting burst access circuitry for performing burst access operations with a burst length shift value according to one embodiment of the invention.

FIG. 7 is a block diagram depicting exemplary commands for a burst access operation which uses a burst length shift value according to one embodiment of the invention.

FIG. 8 is a flow diagram depicting a process for performing a burst access operation with a burst length shift value according to one embodiment of the invention.

FIG. 9 is a timing diagram depicting a burst access operation performed with a burst length shift value according to one embodiment of the invention.

FIG. 10 is a block diagram depicting a burst length shifter according to one embodiment of the invention.

FIG. 11 is a timing diagram depicting an exemplary burst length shifting operation according to one embodiment of the invention.

### DETAILED DESCRIPTION OF THE PREFERRED EMBODIMENT

Embodiments of the invention generally provide a method and apparatus for performing a burst access operation for a memory device. In one embodiment, the method includes receiving a burst access command for the burst access operation and receiving a burst length modifying value for the burst access operation. A modified burst length is generated from a pre-programmed burst length using the burst length modifying value. The modified burst length is used for the burst access operation without changing the pre-programmed burst length. The burst access operation is performed with the modified burst length.

Embodiments of the invention may generally be used with any type of memory. In one embodiment, the memory may be a circuit included on a device with other types of circuits. For example, the memory may be integrated into a processor device, memory controller device, or other type of integrated circuit device. Devices into which the memory is integrated may include system-on-a-chip (SOC) devices. In another embodiment, the memory may be provided as a memory device which is used with a separate memory controller device or processor device.

In both situations, where the memory is integrated into a device with other circuits and where the memory is provided as a separate device, the memory may be used as part of a larger computer system. The computer system may include a motherboard, central processor, memory controller, the memory, a hard drive, graphics processor, peripherals, and any other devices which may be found in a computer system. The computer system may be part of a personal computer, a server computer, or a smaller system such as an embedded system, personal digital assistant (PDA), or mobile phone.

In some cases, a device including the memory may be packaged together with other devices. Such packages may include any other types of devices, including other devices with the same type of memory, other devices with different types of memory, and/or other devices including processors and/or memory controllers. Also, in some cases, the memory may be included in a device mounted on a memory module. The memory module may include other devices including memories, a buffer chip device, and/or a controller chip device. The memory module may also be included in a larger system such as the systems described above.

In some cases, embodiments of the invention may be used with multiple types of memory or with a memory which is included on a device with multiple other types of memory. The memory types may include volatile memory and non-volatile memory. Volatile memories may include static random access memory (SRAM), pseudo-static random access memory (PSRAM), and dynamic random access memory (DRAM). DRAM types may include single data rate (SDR) DRAM, double data rate (DDR) DRAM, low power (LP) DDR DRAM, and any other types of DRAM. Nonvolatile memory types may include magnetic RAM (MRAM), flash memory, resistive RAM (RRAM), ferroelectric RAM (FeRAM), phase-change RAM (PRAM), electrically erasable programmable read-only memory (EEPROM), laser programmable fuses, electrically programmable fuses (e-fuses), and any other types of nonvolatile memory.

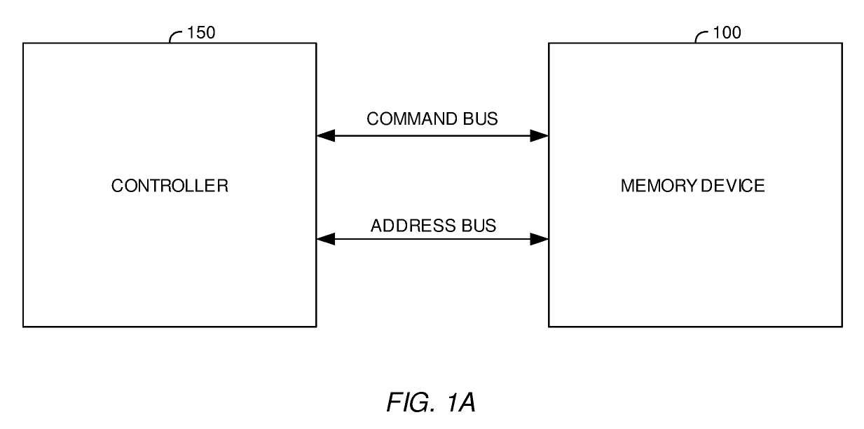

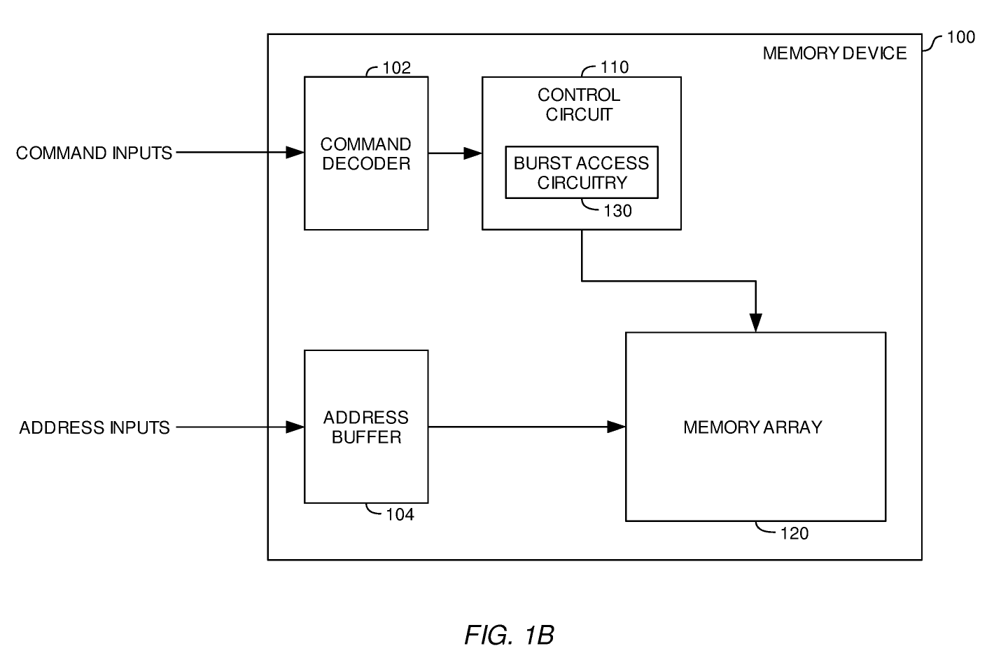

FIG. 1A is a block diagram depicting a memory device 100 and a controller 150 configured to access the memory device according to one embodiment of the invention. The controller 150 may be a memory controller, processor, or any other type of controller. The controller 150 may be configured to issue commands to the memory device 100 as well as send and receive data to and from the memory device 100. The commands issued by the controller 150 may include mode register set commands, activate commands, burst access commands (e.g., burst read commands or burst write commands), and any other appropriate commands used to control the memory device 100. When issuing burst access commands, the controller 150 may be configured to provide a burst length modifying value. The burst length modifying value may include a burst length start value and/or a burst length shift value, each of which are described in greater detail below. Also, as described below, the controller 150 may be configured to provide the burst length start value and/or burst length shift value to the memory device 100 via one or more address pins of the memory device 100.

FIG. 1B is a block diagram depicting the memory device 100 according to one embodiment of the invention. The memory device 100 may include address inputs and command inputs. The address inputs may be received by an address buffer 104 and the command inputs may be receive by a command decoder 102. The command decoder 102 may decode commands and provide decoded command information to a control circuit 110. The control circuit 110 may use the decoded command information in addition to the address inputs to access information in a memory array 120. In some cases, the device 100 may include multiple memory arrays 120 which may be accessed. The control circuit 110 may also include burst access circuitry 130 which may be used to perform burst access operations as described in greater detail below.

In one embodiment of the invention the memory device 100 may be capable of performing burst access operations such as a burst read operation or a burst write operation. To perform a burst access, the memory device 100 may be placed in a burst mode, for example, using a mode register set command to enable the burst mode. A mode register set command may also be used to provide a burst length for burst access operations performed by the memory device 100. The burst length may refer to the number of items of data transmitted during a burst access operation. Subsequent burst access operations may use the pre-programmed burst length to perform the burst access.

After the burst access mode has been enabled, a subsequent burst access may begin when an access command such as a read or write command is received. The access command may include an address at which the burst access is to begin. During the burst access, a row in the memory array 120 corresponding to the address may be activated by an activate command. After the row address for the activate command has been received, the same row address and activated row may be used for subsequent accesses of the burst access operation without the row address being provided again by another access command. Accordingly, after the row activation has been performed, an initial access command may then be used to access a single item of information in the activated row while subsequent accesses may be used to access other items of information in the same activated row. After a number of accesses equal to the burst length have been performed, the burst access may be complete. Subsequently received access commands may be used to perform other burst access operations.

In one embodiment, where the burst access operation is performed in a single data rate (SDR) memory device, the each access in the burst operation may be performed on a single edge of a clock signal. For example, each access for the entire burst access operation may be performed on the rising edge of a clock signal. Where the burst access operation is performed in a double data rate (DDR) memory device, each access in the burst access operation may be performed on successive rising and falling edges of the clock signal (e.g., the burst operation may last one clock cycle for a burst length of two, two clock cycles for a burst length of four, etc.). In one embodiment, the clock signal may be a clock signal generated by the memory device 100. Optionally, the clock signal may be an external clock signal received from the controller 150 which is accessing the memory device 100.

As mentioned above, in some cases, there may be a desire to perform burst access operations with burst lengths other than the pre-programmed burst length. One option might be to issue an additional mode register set command to the memory device 100 changing the pre-programmed burst length. However, such a change may take additional clock cycles while the mode register set command is being performed. In some cases, there may be a desire to avoid executing the additional mode register set command and using the additional clock cycles.

One embodiment of the invention provides a method for modifying the pre-programmed burst length used by the memory device 100 during a burst access operation. During the burst access operation, a burst access command may be received. In addition to the burst access command, a burst length modifying value may be received. The burst length modifying value may modify the pre-programmed burst length used for the burst access operation. In one embodiment, the burst length modifying value may not permanently change the pre-programmed burst length. By using a burst length modifying value to modify the pre-programmed burst length used for a given burst operation, the memory device 100 may be able to perform a variety of differently sized burst access operations without requiring execution of additional commands (e.g., without additional mode register set commands which change the pre-programmed burst length).

Providing a Burst Length Start Value

The burst length modifying value may modify the pre-programmed burst length in a number of different ways. For example, in one embodiment of the invention, the burst length modifying value may be a burst length start value. The burst length start value may provide a starting value for a burst length counter which counts the number of clock cycles for the burst access operation. When the counter has counted a number of cycles corresponding to the pre-programmed burst length, the burst access operation may be terminated. By changing the initial count, the pre-programmed burst length of the burst operation may be changed. In one embodiment, the burst length start value may only be used during the single burst access operation for which the burst length start value is received. Thus, the burst length start value may only temporarily modify the pre-programmed burst length value for the burst access operation without changing the pre-programmed burst length value.

For example, if the memory device 100 is a DDR memory device with a pre-programmed burst length of four (BL4), then a full burst access operation may last two clock cycles. Where a burst length start value of zero is provided, the full burst access operation with the pre-programmed length may be performed. For example, the burst length counter 306 may begin at a count of zero clock cycles and finish at a count of one clock cycles, for a total of two clock cycles with four items of information transferred (two items during clock cycle zero and two items during clock cycle one). If, however, a burst length start value of one is provided where the pre-programmed burst length is four, then the burst length counter 306 may begin and finish at one, thereby counting a single clock cycle with two items of information transferred resulting in a burst length of two.

Table 1 depicts additional pre-programmed burst lengths and the effect of given burst length start values on the total burst length of a burst access operation. The first column indicates the pre-programmed burst length (BL), the second column indicates the number of clock cycles at which the burst access operation (as counted by the burst length counter) is completed, and the remaining columns indicate the resulting burst length for a given burst length start value (BLstart) of zero, one, two, and three. For example, for a programmed burst length BL of BL8, the number of clock cycles may be 4. Where BLstart is ‘10’ (two), the effective burst length may be BL4. In one embodiment, additional bits may be provided for the BLstart value, thereby increasing the number of effectively obtainable burst lengths for a pre-programmed burst length of 16 (e.g., three burst length start bits may be used to provide burst lengths from BL16 to BL2).

TABLE 1
Burst Length Start Values

| | Number of | | | | |
|---|---|---|---|---|---|
| | Clock | BLstart = | BLstart = | BLstart = | BLstart = |
| BL | Cycles | ‘00’ | ‘01’ | ‘10’ | ‘11’ |
| BL2 | 1 | BL2 | N/A | N/A | N/A |
| BL4 | 2 | BL4 | BL2 | N/A | N/A |
| BL8 | 4 | BL8 | BL6 | BL4 | BL2 |
| BL16 | 8 | BL16 | BL14 | BL12 | BL10 |

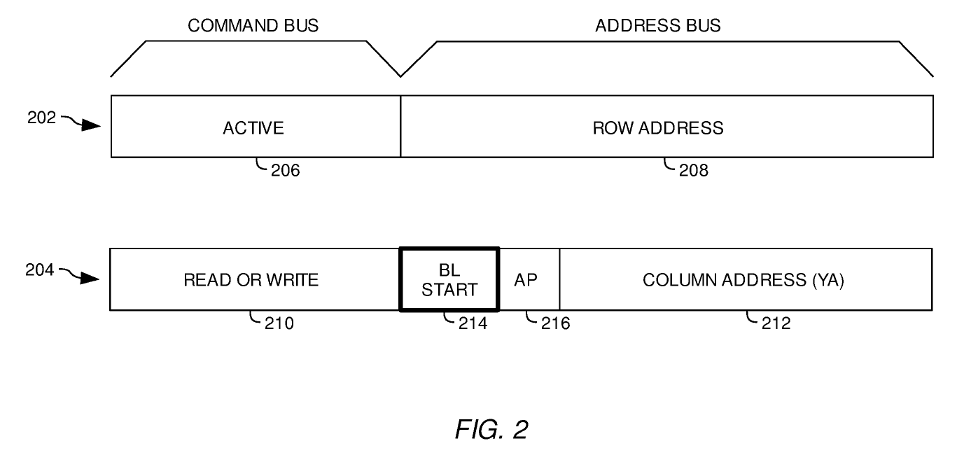

FIG. 2 is a block diagram depicting exemplary commands for a burst access operation which uses a burst length start value according to one embodiment of the invention. As depicted, the commands may include an activate command 202 and an access command 204 (e.g., a read or write command). The activate command 202 may include command bits 206 transmitted across a command bus and row address bits 208 transmitted across an address bus. The row address buts 208 may indicate a row address to be activated by the command 202.

A subsequently received access command 204 may begin the burst access operation. The command 204 may include command bits 210 which indicate whether the burst access operation is a burst read or a burst write. The access command 204 may also include column address bits 212 which indicate where the burst access operation is to begin. In one embodiment of the invention, the burst length start value 214 may be provided with the first burst access command 204. Furthermore, in one embodiment, the burst length start value may be transmitted across the address bus using address bus pins which are not used for the column address 212. In some cases, other command data may also be transmitted across the address bus, such as auto-precharge bits 216 which may be used to perform automatic precharging.

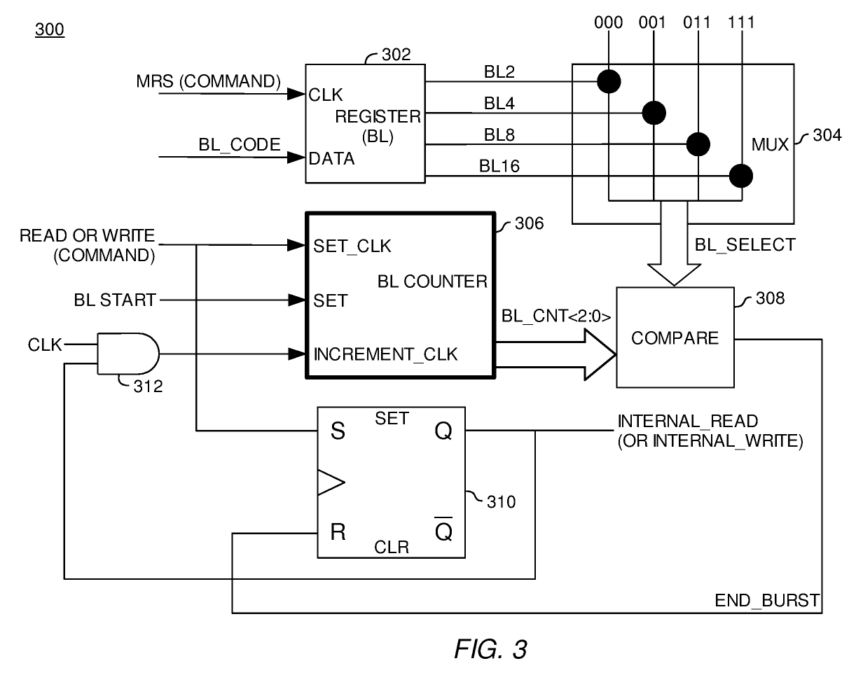

FIG. 3 is a block diagram depicting burst access circuitry 300 (which may be included in the circuitry 130 depicted in FIG. 1) for performing burst access operations according to one embodiment of the invention. The circuitry 300 may be included, for example, as part of the control circuit 110 as described above. As depicted, the circuitry 300 may include a burst length register 302 which stores a programmed burst length (BL_Code) and a multiplexer 304 which indicates the number of clock cycles to be used for a given burst length stored by the burst length register 302. In one embodiment, the programmed burst length BL_Code may be changed by issuing a mode register set (MRS) command to the memory device 100.

The circuitry 300 may also include a burst length counter 306 which is used to count the clock cycles for a given burst access operation. When a burst access operation is initiated, the burst length counter 306 may be set to the burst length start value, BLstart, and the set-reset (SR) register 310 may be set. When the SR register 310 is set, the internal access (e.g., an internal read or write) for the burst access operation may be initiated.

In one embodiment, the count maintained by the burst length counter 306 may be incremented to count each cycle of the received clock signal CLK until an End_Burst signal is received by the AND gate 312. Comparator circuit 308 may be used to compare the burst length count (BL_Count<2:0>) provided by the burst length counter 306 to the number of burst length cycles (BL_Select) provided by the multiplexer 304. When the counted number of cycles is equal to the total number of cycles indicated by the pre-programmed burst length, the comparator circuit 308 may assert the signal End_Burst indicating the end of the burst operation. The asserted End_Burst signal may cause the SR register 310 to be reset, thereby stopping the internal access for the burst access operation and causing the burst length counter 306 to stop counting clock cycles via the AND gate 312.

As described above, the burst length start value may be used to change the length of the burst access operation, for example, by giving an initial counter value which is higher than the default value of zero. When the value counted by the counter 306 reaches the number of cycles corresponding to the pre-programmed burst length, the burst access operation may be completed, as described above with respect to Table 1.

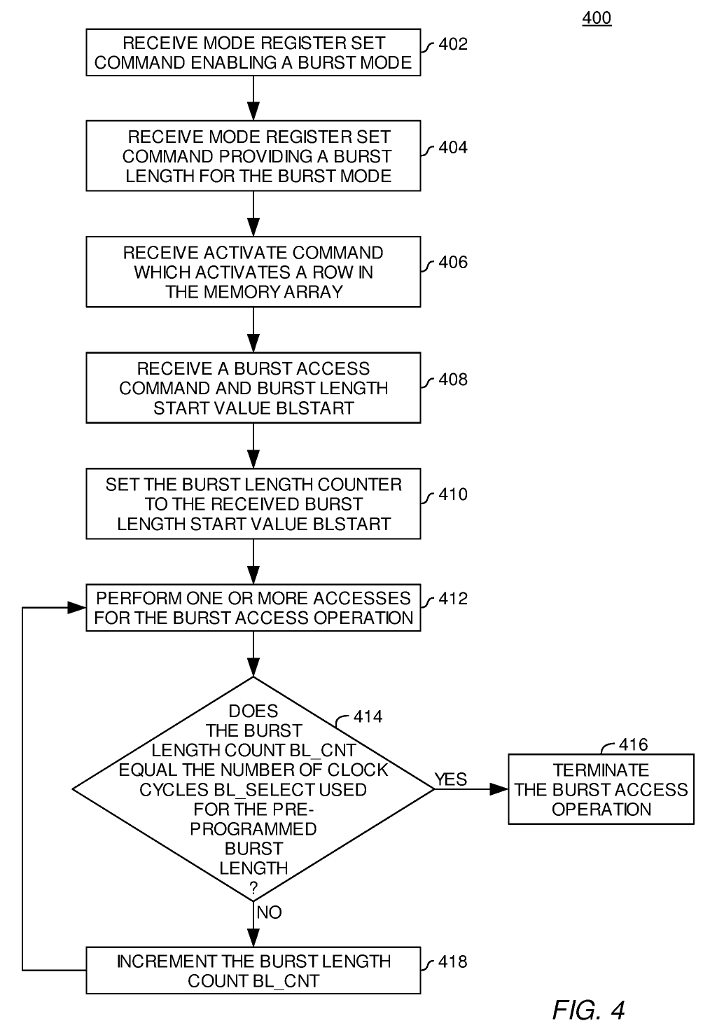

FIG. 4 is a flow diagram depicting a process 400 for performing a burst access operation with a burst length start value according to one embodiment of the invention. At step 402, a mode register set command may be received which enables a burst access mode for the memory device 100. At step 404, a mode register set command may be received which programs the burst length to be used by default for a burst access operation. As described above, the pre-programmed burst length may be stored in the burst length register 302. Then, at step 406, an activate command 202 may be received, causing a row in the memory array 120 to be activated.

At step 408, a burst access command 204 and burst length start value BLstart may be received. The burst access command may initiate the burst access operation and may be either a read or a write command. At step 410, the burst length counter 306 may be set to the received burst length start value BLstart. At step 412, one or more accesses for the burst access operation may be performed. For example, in an SDR DRAM, a single access may be performed on the rising edge of the clock signal CLK. In a DDR DRAM, two accesses may be performed, one on the rising edge of the clock signal CLK and one on the falling edge of the clock signal CLK.

Then, at step 414, a determination may be made of whether the burst length count BL_Cnt provided by the burst length counter 306 is equal to the number of clock cycles BL_Select used for the pre-programmed burst length stored in the burst length register 302. If so, the burst access operation may terminate at step 416. If, however, the count BL_Cnt is not equal to the number of clock cycles BL_Select, then the count BL_Cnt provided by the burst length counter 306 may be incremented at step 418 and the burst access operation may be continued at step 412.

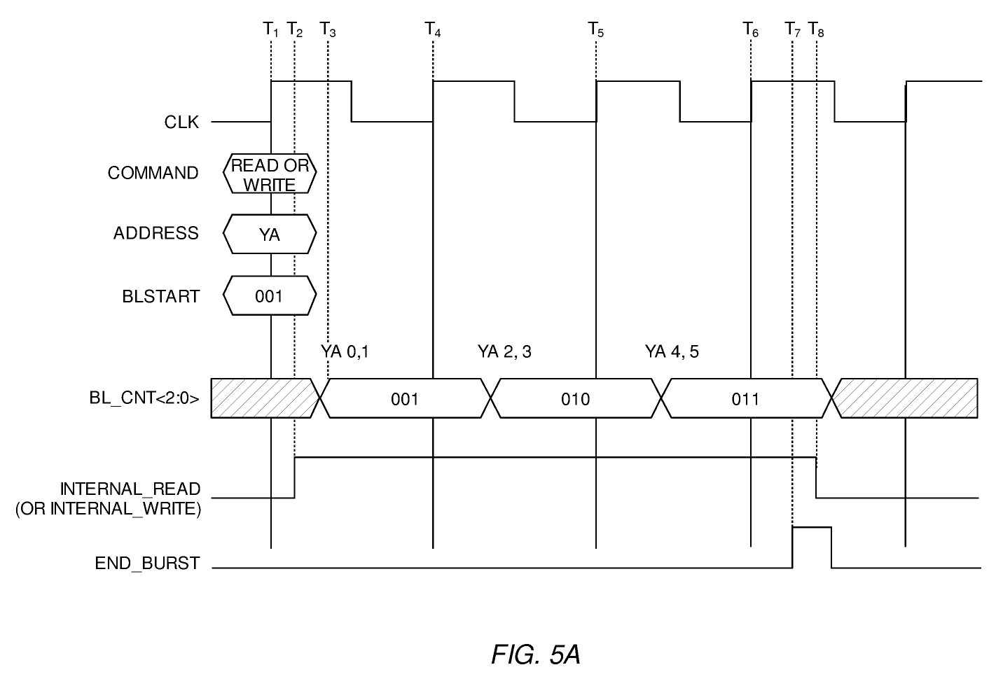

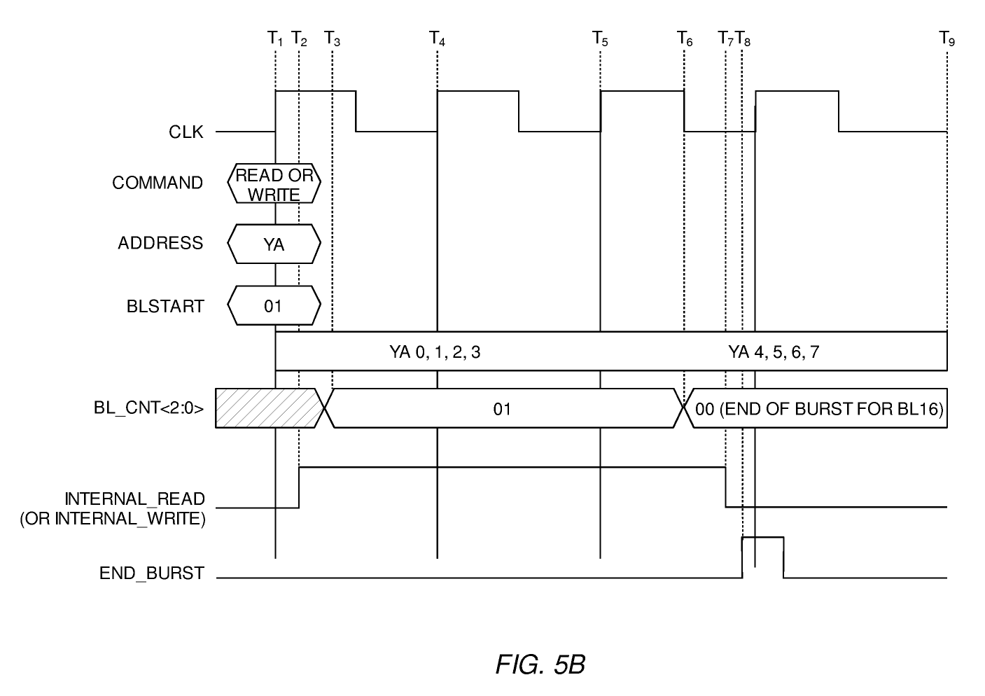

FIG. 5A is a block diagram depicting timing of a burst access operation in a DDR DRAM device with a pre-programmed burst length of eight according to one embodiment of the invention. The burst access operation may begin at time T1 where an access command (e.g., a read or write command) is received across the command bus. Also at time T1, a column address YA may be received across the address bus, as well as the burst length start value BLstart. In the depicted case, the received BLstart value is ‘001’. At time T2, the internal access (e.g., an internal read or write) may be initiated, and at time T3, the burst length count BL_Cnt may be reset to the received BLstart value, ‘001’.

By time T4, the first two accesses of the burst operation may be performed for column addresses YA 0 and YA 1 (e.g., the first and second column addresses, respectively). At time T5, the second two accesses of the burst operation may be performed for column addresses YA 2 and YA 3, and the burst count BL_Cnt may be incremented to two (‘010’). Then, by time T6, the third set of accesses for column addresses YA 4 and YA 5 may be performed and the burst count BL_Cnt may be incremented to three (‘011’).

In one embodiment, the burst count BL_Cnt may be compared to the end of burst value (provided by BL_Select) after a set of accesses (e.g., for two column addresses) has been performed. Thus, when the burst count BL_Cnt is incremented to three and after performing the set of accesses for column addresses YA 4 and YA 5, the comparator circuit 308 may compare the burst count BL_Cnt to the number of clock cycles BL_Select for the burst access operation. Upon comparing the burst count BL_Cnt to the number of clock cycles BL_Select for the burst access operation (for BL8, BL_Select is three), the comparator circuit 308 may indicate that the end of the burst access operation has been reached by asserting the End_Burst signal at time T7. After the End_Burst signal has been asserted, the internal access for the burst access operation may end at time T8.

Providing a Burst Length Start Value for a Decrementing Counter

In one embodiment of the invention, the burst length start value may be used to provide an initial value for a counter 306 which counts down to an end of burst count. Furthermore, in some cases, the counter 306 may be configured to continue counting (e.g., by wrapping around) even after the counter 306 has reached zero, so that more burst length options are available for a given burst length start value. For example, if the counter 306 is a two bit binary counter, if the count is ‘00’ and the counter 306 is decremented, the counter 306 may wrap around to ‘11’ and continue counting down until the end of burst count is received. Table 2 provides exemplary pre-programmed burst length settings (BL), the number of clock cycles used, the end of burst (EOB) value for the burst length setting (provided by the multiplexer 304 as BL_Select), and the effect of difference burst length start values (BLstart) on the length of a burst operation. In the case depicted in Table 2, the counter 306 may only be decremented every other clock cycle (e.g., for a full burst length of four, the counter 306 may count down one time). When the counter reaches the EOB value, the burst operation may terminate.

TABLE 2
Burst Length Start Values with a Decrementing
Counter

| | Number | | | | | |
|---|---|---|---|---|---|---|
| | of Clock | EOB | BLstart = | BLstart = | BLstart = | BLstart = |
| BL | Cycles | value | ‘00’ | ‘01’ | ‘10’ | ‘11’ |
| BL4 | 2 | ‘11’ | BL8 | BL12 | BL16 | BL4 |
| BL8 | 4 | ‘10’ | BL12 | BL16 | BL4 | BL8 |
| BL16 | 8 | ‘00’ | BL4 | BL8 | BL12 | BL16 |

FIG. 5B is a timing diagram depicting a burst access operation using a countdown from the burst length start value according to one embodiment of the invention. For the example depicted in FIG. 5B, the pre-programmed burst length may be BL16 and the BLstart value may be ‘01’. As shown in Table 2, the end of burst value EOB for the pre-programmed burst length BL16 may be ‘00’.

As depicted in FIG. 5B, at time T1, the burst access command (a read or write command) and a column address YA may be received by the memory device. Also at time T1, the burst length start value BLstart of ‘01’ may be received, for example, via the address bus as described above. After the burst access command is received, at time T2, the internal access signal (e.g., internal read signal or internal write signal) may be asserted and the burst access may begin. At time T3, the burst length counter 306 may be reset to the BLstart value, ‘01’, and from times T4 to T5, four column addresses, beginning at column address YA may be accessed by reading or writing to the locations.

At time T6, after two clock periods, the burst length count BL_Cnt maintained by counter 306 may be decremented from ‘01’ to ‘00’. In one embodiment, the burst count BL_Cnt may be compared to the end of burst value (provided by BL_Select) before a set of accesses (e.g., for four column addresses) is performed. Thus, after the counter 306 has decremented BL_Cnt to ‘00’, a set of accesses for the next four column addresses (YA 4, YA 5, YA 6, and YA 7) may begin at time T6. Also, the comparator circuit 308 may determine that the counter value BL_Cnt is equal to the end of burst value EOB of ‘00’ After the comparator circuit 308 determines that the counter value BL_Cnt is equal to the end of burst value EOB, the internal access signal (e.g., the internal read signal or internal write signal) may be lowered at time T7 and at time T8 the end of burst signal End_Burst may be asserted, thereby indicating the end of the burst access operation.

In general, the embodiments described above with respect to providing a burst length start value which is used by a counter to modify a pre-programmed burst length value may be used with any type of counter and with any corresponding increments or decrements of burst length desired. Furthermore, embodiments of the invention may be utilized with any pre-programmed burst length values, burst length start values, and any end of burst values.

Providing a Burst Length Shift Value

In one embodiment of the invention, a burst length shift value may be used to modify a pre-programmed burst length value. The modification provided by the burst length shift value may, for example, be used for a single burst access operation (e.g., the burst length shift value may only temporarily replace the pre-programmed burst length value) without changing the pre-programmed burst length value. In one embodiment, the burst length shift value may modify the pre-programmed burst length value used for a burst access operation by shifting the pre-programmed burst length value to one of plurality of other burst length values. For example, as described below, the burst length shift value may shift the pre-programmed burst length value to a lower burst length value. Optionally, the burst length shift value may provide a modified burst length value by rotating from the pre-programmed burst length value to through a plurality of higher and/or lower burst length values.

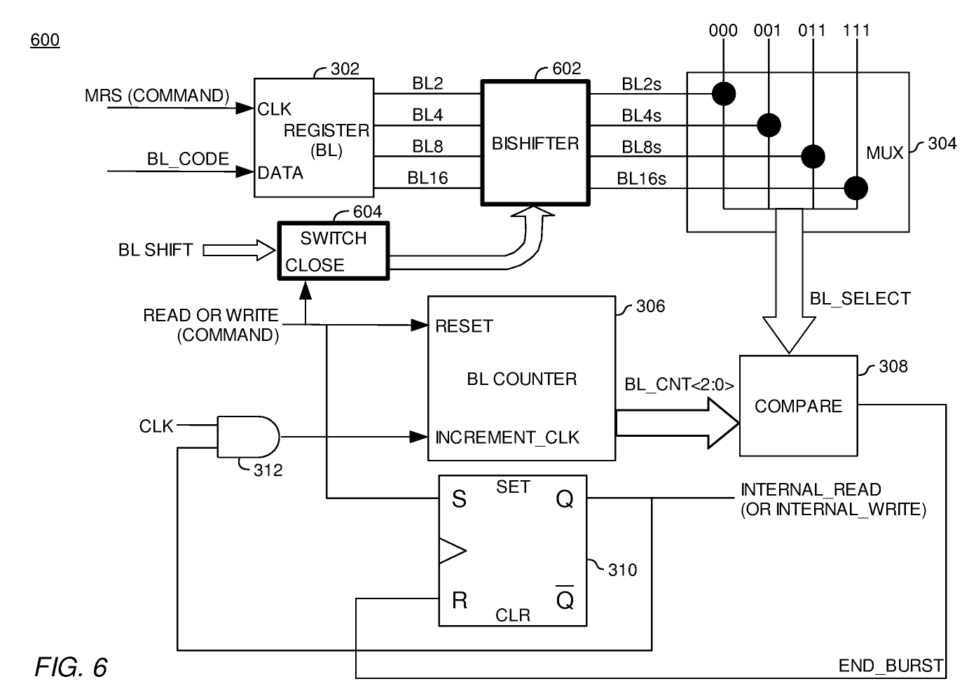

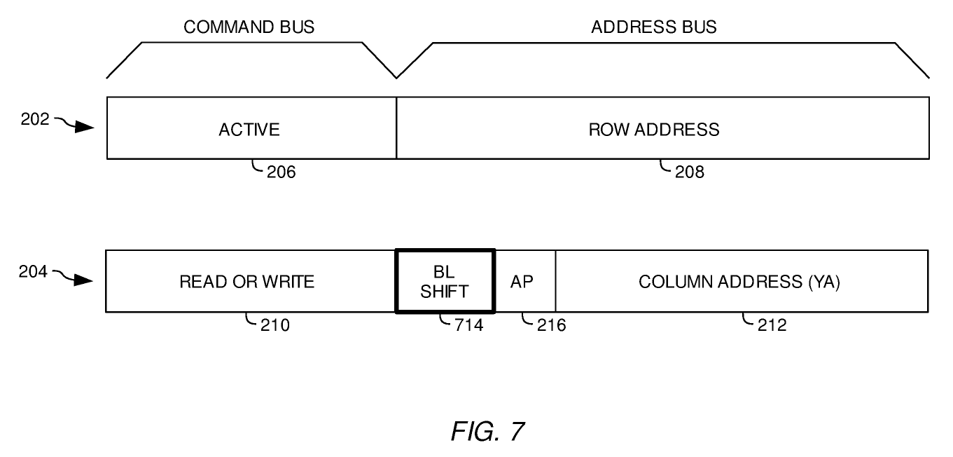

FIG. 6 is a block diagram depicting burst access circuitry 600 (which may be included in the circuitry 130 depicted in FIG. 1) for performing burst access operations with a burst length shift value BLshift according to one embodiment of the invention. In one embodiment, as depicted in FIG. 7, the burst length shift value BLshift 714 may be received with a burst access command 204 such as a read or write command. Like the burst length start value, the burst length shift value BLshift 714 may be received via one or more address bus pins as depicted in FIG. 7.

When BLshift is received by the circuitry 600, a switch 604 may be used to store BLshift. The stored BLshift may be provided to a burst length shifter 602 which receives a pre-programmed burst length from the burst length register 302 and provides a shifted burst length value (BL2s, BL4s, BL8s, BL16s) to multiplexer 304. As described above with respect to FIG. 3, the multiplexer 304 may then provide the number of clock cycles to be used for the burst access operation, thereby modifying the burst length of the burst access operation. Table 3 depicts the effect of a given BLshift value on a pre-programmed burst length BL according to one embodiment of the invention.

TABLE 3
Burst Length Shift Values

| | BLshift = | BLshift = | BLshift = | BLshift = |
|---|---|---|---|---|
| BL | ‘00’ | ‘01’ | ‘10’ | ‘11’ |
| BL2 | BL2 | BL2 | BL2 | BL2 |
| BL4 | BL4 | BL2 | BL2 | BL2 |
| BL8 | BL8 | BL4 | BL2 | BL2 |
| BL16 | BL16 | BL8 | BL4 | BL2 |

As depicted, in one embodiment, the BLshift value may shift the pre-programmed burst length to a lower setting which is not less than the lowest setting, in this case, of BL2. For example, where BLshift is ‘01’, the pre-programmed burst length may be shifted downwards by one setting, for example, from a pre-programmed burst length of BL8 to a shifted burst length setting of BL4. If the pre-programmed burst length setting is already BL2, no shifting may be performed. Also, where BLshift is ‘00’, no shifting of the pre-programmed burst length setting may be performed.

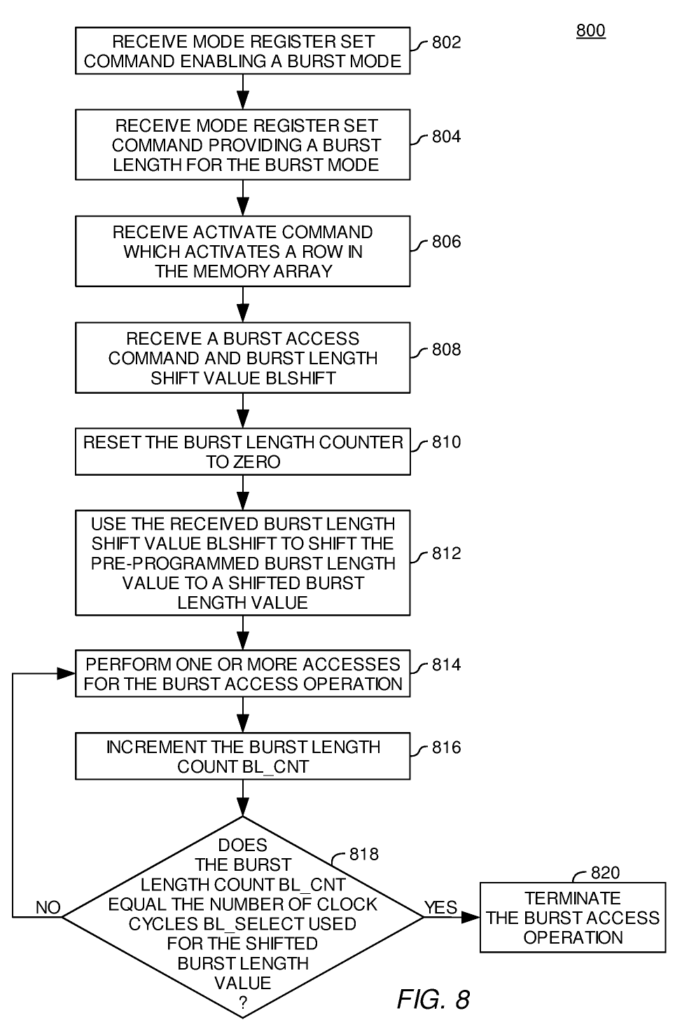

FIG. 8 is a flow diagram depicting a process 800 for performing a burst access operation with a burst length shift value according to one embodiment of the invention. At step 802, a mode register set command may be received which enables a burst access mode for the memory device 100. At step 804, a mode register set command may be received which programs the burst length to be used by default for a burst access operation. As described above, the pre-programmed burst length may be stored in the burst length register 302. Then, at step 806, an activate command 202 may be received, causing a row in the memory array 120 to be activated.

At step 808, a burst access command 204 and burst length shift value BLshift may be received. The burst access command may initiate the burst access operation and may be either a read or a write command. At step 810, the burst length counter 306 may be reset to zero. At step 812, the received burst length shift value BLshift may be used to shift the pre-programmed burst length value (e.g., the value programmed at step 804) to a shifted burst length value, for example, as described above with respect to Table 3. At step 814, one or more accesses for the burst access operation may be performed. For example, in an SDR DRAM, a single access may be performed on the rising edge of the clock signal CLK. In a DDR DRAM, two accesses may be performed, one on the rising edge of the clock signal CLK and one on the falling edge of the clock signal CLK.

At step 816, the count BL_Cnt provided by the burst length counter 306 may be incremented. Then, at step 818, a determination may be made of whether the burst length count BL_Cnt provided by the burst length counter 306 is equal to the number of clock cycles BL_Select used for the shifted burst length value provided by the burst length shifter 602. If so, the burst access operation may terminate at step 820. If, however, the count BL_Cnt is not equal to the number of clock cycles BL_Select, the burst access operation may be continued at step 814.

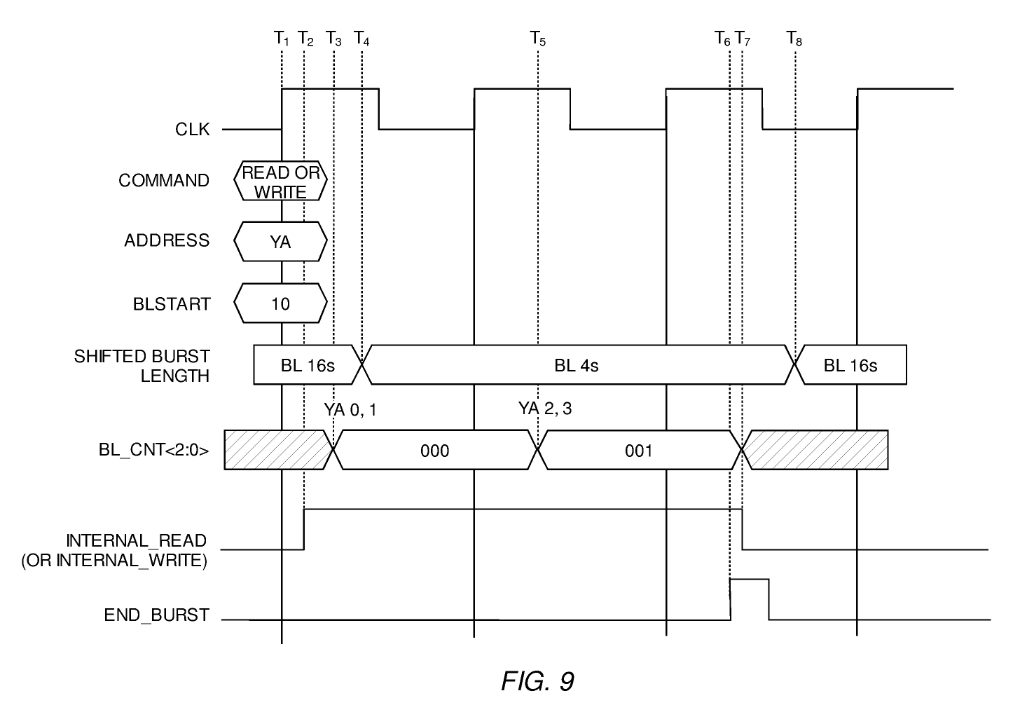

FIG. 9 is a timing diagram depicting a burst access operation performed with a burst length shift value BLshift according to one embodiment of the invention. At time T1, a burst access command may be received with a column address YA and a burst length shift value BLshift, in this case, of ‘10’ (two). At time T2, an internal access signal (e.g., for an internal read or internal write) may be asserted, and at time T3 the burst length count BL_Cnt may be reset to zero. Then, at time T4, the received BLshift value may be used to shift the pre-programmed burst length (in this case, BL16) downwards to a shifted burst length value. In the case depicted in FIG. 9, the burst length of BL16 may be shifted downwards two to a shifted burst length value of BL4.

As described above, for a burst length of BL4, the burst access operation may last for two clock cycles with an end of burst value of ‘001’. Thus, from time T3 to T6, the burst access operation may be performed, with column addresses YA 0 and YA 1 being accessed from times T3 to T5 and column addresses YA 2 and YA 3 being accessed from times T5 to T6. At time T6, the End_Burst signal may be asserted when the comparator circuit 308 determines that the burst length count BL_Cnt is equal to the end of burst value BL_Select (both of which are equal to ‘001’). Then, at time T7, after the burst access operation has been completed, the internal access signal may be lowered, and at time T8, the shifted burst length value used for the burst access operation may be reset to the pre-programmed burst length value in preparation for a subsequent burst access operation.

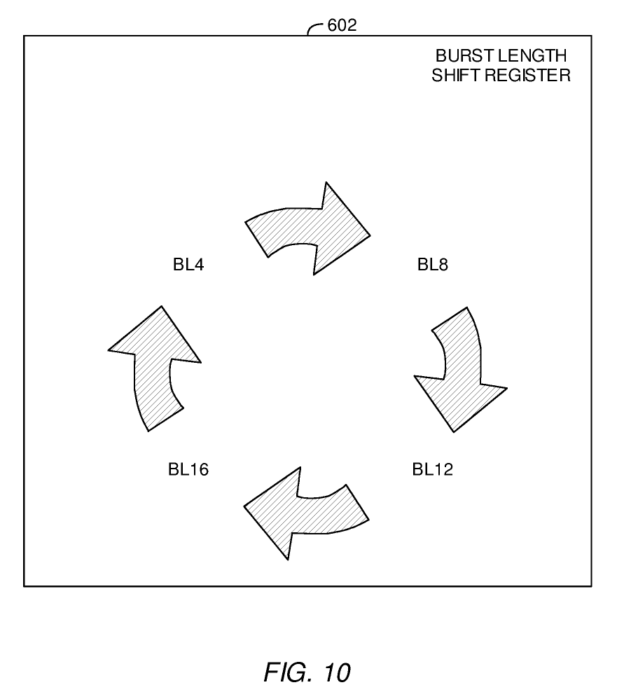

As mentioned above, in one embodiment of the invention, the burst length shift value BLshift may be used to provide a shifted burst length value which rotates through a plurality of possible burst length settings. For example, as depicted in FIG. 10, burst length shifter 602 may shift the pre-programmed burst length provided by the burst length register 302 through one of the burst length settings of BL4, BL8, BL12, and BL16. For example, if the pre-programmed burst length is BL4 and a shift of two is performed, the resulted shifted burst length value may be BL8. If the pre-programmed burst length is BL16 and a shift of one is performed, the shifted burst length may wrap around to BL4.

Table 4 depicts the effect of a given burst length shift value BLshift on a pre-programmed burst length value according to one embodiment of the invention. Where BLshift is ‘11’, no shift of the pre-programmed burst length value may be performed. Where BLshift is ‘10’, the pre-programmed burst length value may be shifted by one, for example, from BL16 to BL4.

TABLE 4
Burst Length Shift Values

| | BLshift = | BLshift = | BLshift = | BLshift = |
|---|---|---|---|---|
| BL | ‘00’ | ‘01’ | ‘10’ | ‘11’ |
| BL4 | BL16 | BL12 | BL8 | BL4 |
| BL8 | BL4 | BL16 | BL12 | BL8 |
| BL16 | BL12 | BL8 | BL4 | BL16 |

In general while described with respect to four possible shifted burst length settings, any number of possible burst length settings may be used by the burst length shifter 602. Furthermore, any direction of shift (e.g., upwards shifting, downwards shifting, wrapping around, or not wrapping around) may be utilized by the burst length shifter 602.

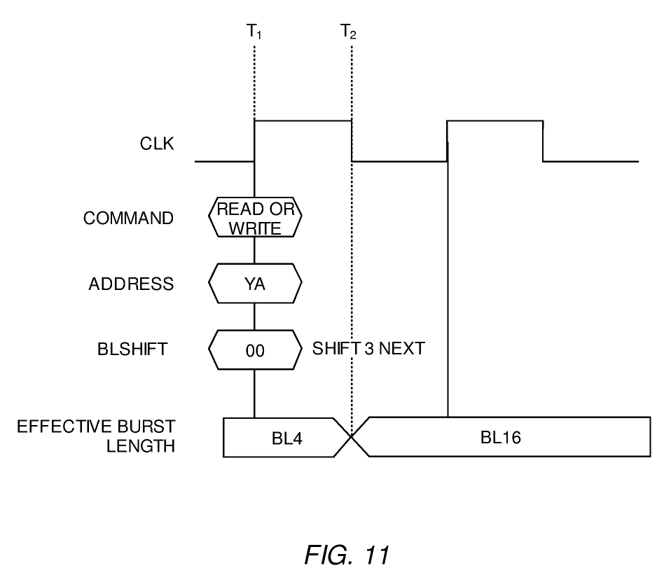

FIG. 11 is a timing diagram depicting an exemplary burst length shifting operation according to one embodiment of the invention. As depicted, at time T1, an access command, column address YA, and burst length shift value BLshift may be received. In the depicted case, the pre-programmed burst length value may be BL4 and BLshift may be ‘00’, thereby providing a shift of three from the pre-programmed burst length setting. Thus, at time T2, the effective burst length used by the memory device 100 may be shifted from BL4 to BL16. The shifted burst length of BL16 may then be used to perform a burst access operation.

As described above, embodiments of the invention provide a burst modifying value which may be used to modify a pre-programmed burst length value. In some cases, the burst modifying value may be provided without requiring lengthy programming overhead (e.g., without requiring mode register set commands to be issued to the memory device 100). For example, the modifying value may be provided as part of a burst access command for which the burst length is being modified. As a result, the memory device 100 may provide flexible burst length modifications while performing a large number of successive burst access operations.

While the foregoing is directed to embodiments of the present invention, other and further embodiments of the invention may be devised without departing from the basic scope thereof, and the scope thereof is determined by the claims that follow.

What is claimed is:

1. A method for performing a burst access operation for a memory device, comprising:
receiving a burst access command for the burst access operation;
receiving a burst length modifying value for the burst access operation;
generating a modified burst length from a pre-programmed burst length using the burst length modifying value, wherein the modified burst length is used for the burst access operation without changing the pre-programmed burst length; and
performing the burst access operation with the modified burst length.

2. The method of claim 1, wherein the burst length modifying value is received simultaneously with the burst access command for the burst access command.

3. The method of claim 1, wherein the burst access command is a first command of the burst access operation.

4. The method of claim 1, wherein each burst access for the burst access operation is performed on successive rising and falling edges of a clock signal.

5. The method of claim 1, wherein the pre-programmed burst length is programmed by issuing a mode register set command to the memory device.

6. The method of claim 1, wherein the burst length modifying value is received by the memory device on one or more address pins of the memory device.

7. A memory device, comprising:
circuitry configured to:
receive a burst access command for a burst access operation;
receive a burst length modifying value for the burst access operation;
generate a modified burst length from a pre-programmed burst length using the burst length modifying value, wherein the modified burst length is used for the burst access operation without changing the pre-programmed burst length; and
perform the burst access operation with the modified burst length.

8. The memory device of claim 7, wherein the circuitry is configured to receive the burst length modifying value simultaneously with the burst access command for the burst access command.

9. The memory device of claim 7, wherein the circuitry is configured to receive the burst access command as a first command of the burst access operation.

10. The memory device of claim 7, wherein the circuitry is configured to perform each burst access for the burst access operation on successive rising and falling edges of a clock signal.

11. The memory device of claim 7, wherein circuitry is configured to receive the pre-programmed burst length via a mode register set command issued to the memory device.

12. The memory device of claim 7, wherein the circuitry is configured to receive the burst length modifying value via one or more address pins of the memory device.

13. A controller, comprising:
circuitry configured to:
issue a burst access command for a burst access operation to a memory device;
provide a burst length modifying value for the burst access operation to the memory device, wherein the burst length modifying value is used to generate a modified burst length from a pre-programmed burst length,
wherein the modified burst length is used for the burst access operation without changing the pre-programmed burst length; and
perform the burst access operation with the modified burst length.

14. The controller of claim 13, wherein circuitry is configured to provide the burst length modifying value simultaneously with the burst access command for the burst access command.

15. The controller of claim 13, wherein the burst access command is a first command of the burst access operation provided by the circuitry.

16. The controller of claim 13, wherein the circuitry is configured to perform each burst access for the burst access operation on successive rising and falling edges of a clock signal.

17. The controller of claim 13, wherein the circuitry is configured to provide the pre-programmed burst length to the memory device by issuing a mode register set command to the memory device.

18. The controller of claim 13, wherein the circuitry is configured to provide the burst length modifying value to the memory device on one or more address pins of the memory device.

19. A method for performing a burst access operation for a memory device, comprising:
receiving a burst access command for the burst access operation;
receiving a burst start value for the burst access operation;
initializing a counter to the burst start value; and
determining a length of the burst access operation using the counter initialized to the burst start value, wherein the burst access operation is completed when the counter reaches an end of burst value.

20. The method of claim 19, wherein the burst start value is received simultaneously with the burst access command.

21. The method of claim 20, wherein the burst access command is a first command of the burst access operation.

22. The method of claim 19, wherein each burst access for the burst access operation is performed on successive rising and falling edges of a clock signal.

23. The method of claim 19, wherein the burst start value is received by the memory device on one or more address pins of the memory device.

24. The method of claim 19, wherein the counter is decremented from the burst start value until the counter reaches the end of burst value, thereby indicating that the burst access operation is completed.

25. A method for performing a burst access operation for a memory device, comprising:
receiving a burst access command for the burst access operation;
receiving a burst shift value for the burst access operation;
generating a modified burst length from a pre-programmed burst length by shifting the pre-programmed burst length to one of a plurality of shifted burst length values using the burst shift value; and
performing the burst access operation with the modified burst length.

26. The method of claim 25, wherein the modified burst length is used for the burst access operation without changing the pre-programmed burst length.

27. The method of claim 25, wherein the burst shift value is received simultaneously with the burst access command.

28. The method of claim 27, wherein the burst access command is a first command of the burst access operation.

29. The method of claim 25, wherein each burst access for the burst access operation is performed on successive rising and falling edges of a clock signal.

30. The method of claim 25, wherein the burst shift value is received by the memory device on one or more address pins of the memory device.

31. The method of claim 25, wherein the burst shift value is used to generate the modified burst length by shifting the pre-programmed burst length to a lower burst length than the pre-programmed burst length.

32. The method of claim 25, wherein the burst shift value is used to shift the pre-programmed burst length to one of the plurality of shifted burst length values by rotating through the shifted burst length values beginning from the pre-programmed burst length.
